(19) United States
(12) Patent Application Publication
(10) Pub. No.: US 2012/0040555 A1
(43) Pub. Date: Feb. 16, 2012

(54) Electric connector

(75) Inventors: Ting Chu Shih, Taipei Hsien (TW); Meng Chieh Wu, Taipei Hsien (TW)

(73) Assignee: Aliner Industries, Inc.

(21) Appl. No.: 12/806,438

(22) Filed: Aug. 12, 2010

(51) Int. Cl. H01R 9/05

(52) U.S. Cl. 439/578

(57) ABSTRACT

An electric connector includes an insulating device disposed into a chamber of an adaptor shell, and a receptacle engaged into the bore of the insulating device and having a compartment for receiving an electric cable and having one or more slots for forming or defining one or more blades, the blades each include two side segments and an intermediate segment disposed between the side segments and located in the compartment of the receptacle for engaging with the electric cable and for increasing a contacting area between the blade and the electric cable and for firmly coupling the in-plug electric cable to the receptacle and for decreasing the impedance between the in-plug electric cable and the receptacle and for reducing the return loss of the electric connector.

### BACKGROUND OF THE INVENTION

1. Field of the Invention

The present invention relates to an electric connector, and more particularly to an electric connector including a socket member or receptacle having an increased contacting area with the in-plug electric wire or cable for firmly and stably coupling or connecting the in-plug electric wire or cable to the receptacle of the electric connector and for decreasing the impedance between the in-plug electric wire or cable and the receptacle of the electric connector and for reducing the return loss of the electric connector.

2. Description of the Prior Art

Typical electric connectors comprise one or more socket members for receiving or engaging with the in-plug electric wires or cables and for electrically coupling or connecting the in-plug electric wire or cable to the socket member.

For example, U.S. Pat. No. 4,206,963 to English et al. discloses one of the typical connector filtered adapter assemblies comprising a receptacle disposed in a shell for receiving or engaging with the in-plug electric wires or cables.

However, the receptacle includes a tilted or inclined or tapered structure that may be engaged with the in-plug electric wires or cables in a point or line contact, i.e., the in-plug electric wires or cables are only in line contact with the receptacle such that the contacting area between the in-plug electric wire or cable and the receptacle is small and such that the electric contact between the in-plug electric wire or cable and the receptacle will become fail.

U.S. Pat. No. 5,704,809 to Davis discloses another typical coaxial electrical connector comprising a receptacle contact disposed in an outer shell for receiving or engaging with the in-plug electric wires or cables.

However, the receptacle contact includes a tilted or inclined or tapered structure that may be engaged with the in-plug electric wires or cables in a point or line contact, i.e., the in-plug electric wires or cables are only in line contact with the receptacle contact such that the contacting area between the in-plug electric wire or cable and the receptacle contact is small and such that the electric contact between the in-plug electric wire or cable and the receptacle contact will become fail.

U.S. Pat. No. 6,709,289 to Huber et al. discloses a further typical electrical plug connector comprising an inner conductor part disposed in an outer shell for receiving or engaging with the in-plug electric wires or cables.

However, the inner conductor part includes a tilted or inclined or tapered structure that may be engaged with the in-plug electric wires or cables in a point or line contact, i.e., the in-plug electric wires or cables are only in line contact with the inner conductor part such that the contacting area between the in-plug electric wire or cable and the inner conductor part is small and such that the electric contact between the in-plug electric wire or cable and the inner conductor part will become fail.

The present invention has arisen to mitigate and/or obviate the afore-described disadvantages of the conventional electric connectors.

### SUMMARY OF THE INVENTION

The primary objective of the present invention is to provide an electric connector including a socket member or receptacle having an increased contacting area with the in-plug electric wire or cable for firmly and stably coupling or connecting the in-plug electric wire or cable to the receptacle of the electric connector and for decreasing the impedance between the in-plug electric wire or cable and the receptacle of the electric connector and for reducing the return loss of the electric connector.

In accordance with one aspect of the invention, there is provided an electric connector comprising an adaptor shell including a chamber formed therein, an insulating device disposed into the chamber of the adaptor shell and including a bore formed therein, and a receptacle engaged into the bore of the insulating device and including a compartment formed therein for receiving an electric cable, and including at least one slot formed therein for defining at least one blade, the blade including two side segments and an intermediate segment disposed between the side segments and located in the compartment of the receptacle for engaging with the electric cable and for increasing a contacting area between the blade and the electric cable and for firmly and stably coupling or connecting the in-plug electric wire or cable to the receptacle of the electric connector and for decreasing the impedance between the in-plug electric wire or cable and the receptacle of the electric connector and for reducing the return loss of the electric connector.

The insulating device includes a first insulating member disposed in the chamber and at a first end of the adaptor shell and having a bore formed in the first insulating member, and includes a second insulating member disposed in the chamber and at a second end of the adaptor shell and includes a bore formed in the second insulating member.

The receptacle is engaged into the bore of the first insulating member, and partially engaged into the bore of the second insulating member.

The adaptor shell includes an inner peripheral flange extended radially and inwardly from the first end of the adaptor shell for engaging with the first insulating member.

The receptacle includes a conductor member engaged with the receptacle and extended out of the second insulating member and the adaptor shell.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an electric connector in accordance with the present invention;

FIG. 2 is a partial and longitudinal cross sectional view of the electric connector;

FIG. 3 is a partial and longitudinal cross sectional view similar to FIG. 2, illustrating the operation of the electric connector;

FIG. 4 is a partial and lateral cross sectional view of the electric connector; and

FIG. 5 is a plan schematic view illustrating the curvature of the return loss of the electric connector.

### DETAILED DESCRIPTION OF THE PREFERRED EMBODIMENT

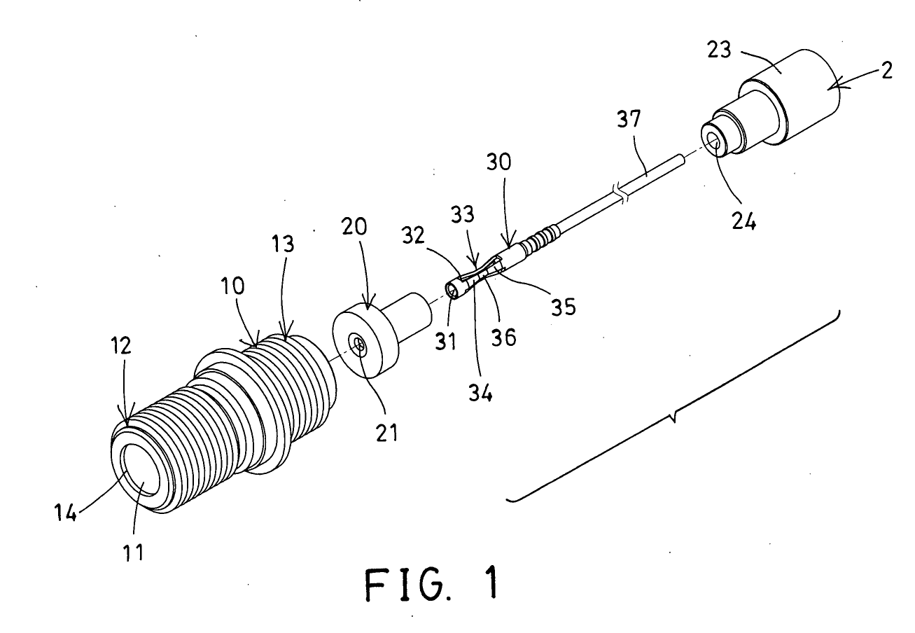

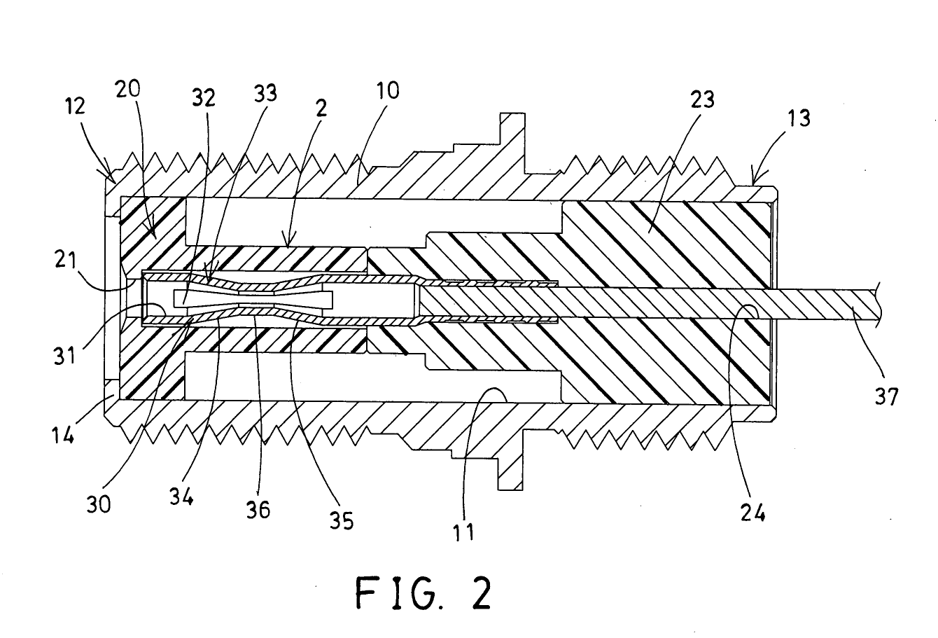

Referring to the drawings, and initially to FIGS. 1-2, an electric connector in accordance with the present invention comprises an outer adaptor shell 10 including a bore or chamber 11 formed therein, an insulating device 2 including a first insulating member 20 disposed or engaged into the chamber 11 and at one end 12 of the adaptor shell 10 and having an orifice or bore 21 formed in the first insulating member 20, and including a second insulating member 23 also disposed or engaged into the chamber 11 but at the other end 13 of the adaptor shell 10 and including an aperture or bore 24 formed in the second insulating member 23.

It is preferable, but not necessarily that the adaptor shell 10 includes an inner peripheral flange 14 extended radially and inwardly from the one end 12 thereof for engaging with the first insulating member 20 and for stably or solidly anchoring or positioning or retaining or confining the first insulating member 20 in the one end 12 of the adaptor shell 10 and for preventing the first insulating member 20 and the second insulating member 23 from moving axially along or relative to the adaptor shell 10.

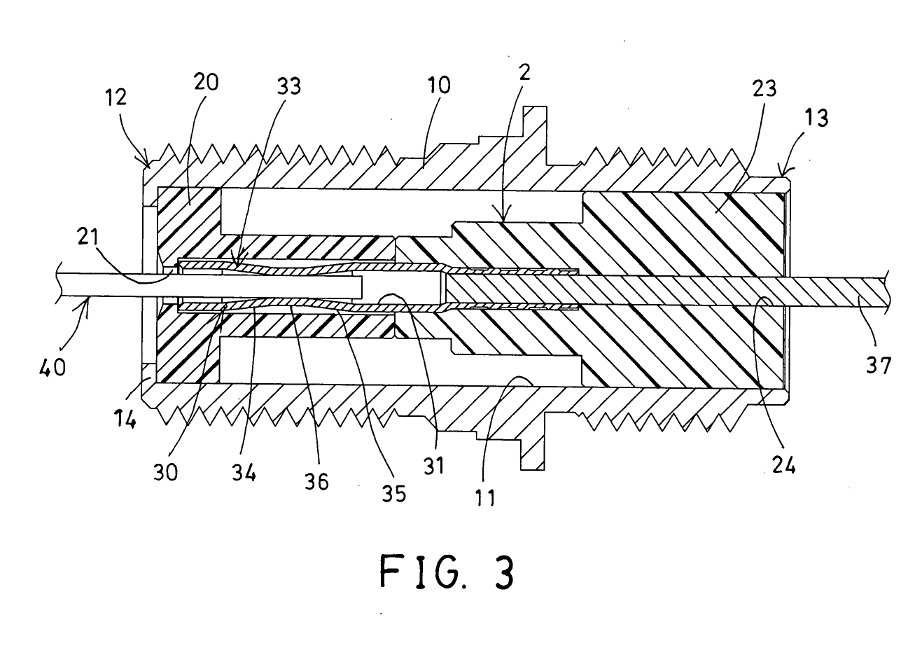

A tubular or cylindrical socket member or receptacle 30 is disposed or engaged into the bore 21 of the first insulating member 20 or of the insulating device 2 and partially engaged into the bore 24 of the second insulating member 23 (FIGS. 2, 3), and includes a bore or compartment 31 formed therein, and includes one or more (such as three) slots 32 formed therein for forming or defining one or more (such as three) spring or resilient blades 33, each blade 33 includes two side tilted or inclined or tapered segments 34, 35 partially extended into the compartment 31 of the receptacle 30 (FIGS. 2-4), and an intermediate segment 36 disposed or located or coupled between the tapered segments 34, 35 and located in the compartment 31 of the receptacle 30 for firmly and stably or suitably engaging with the in-plug electric wire or cable 40 and for suitably increasing the contacting area between the blades 33 and the in-plug electric wire or cable 40 and for allowing the in-plug electric wire or cable 40 to be suitably engaged into the compartment 31 of the receptacle 30.

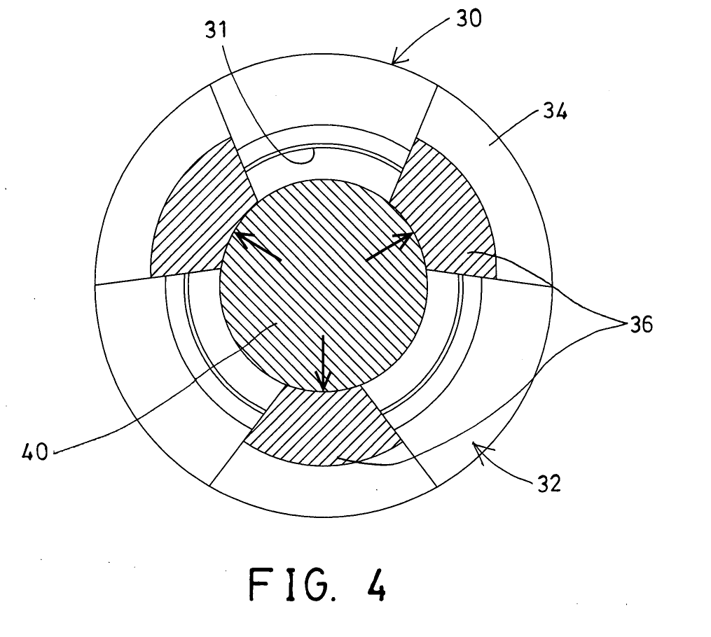

In operation, as shown in FIG. 3, the in-plug electric wire or cable 40 may be engaged into the bore 21 of the first insulating member 20 and suitably engaged into the compartment 31 of the receptacle 30 for suitably engaging with the spring or resilient blades 33, and particularly for suitably engaging with the intermediate segments 36 of the blades 33 and thus for suitably increasing the contacting area between the blades 33 and the in-plug electric wire or cable 40 (FIGS. 3-4) and for decreasing the impedance between the in-plug electric wire or cable 40 and the receptacle 30 of the electric connector and for reducing the return loss of the electric connector. A conductor member 37 may further be provided and engaged with or coupled to the receptacle 30 and extended out of the second insulating member 23 and/or the adaptor shell 10.

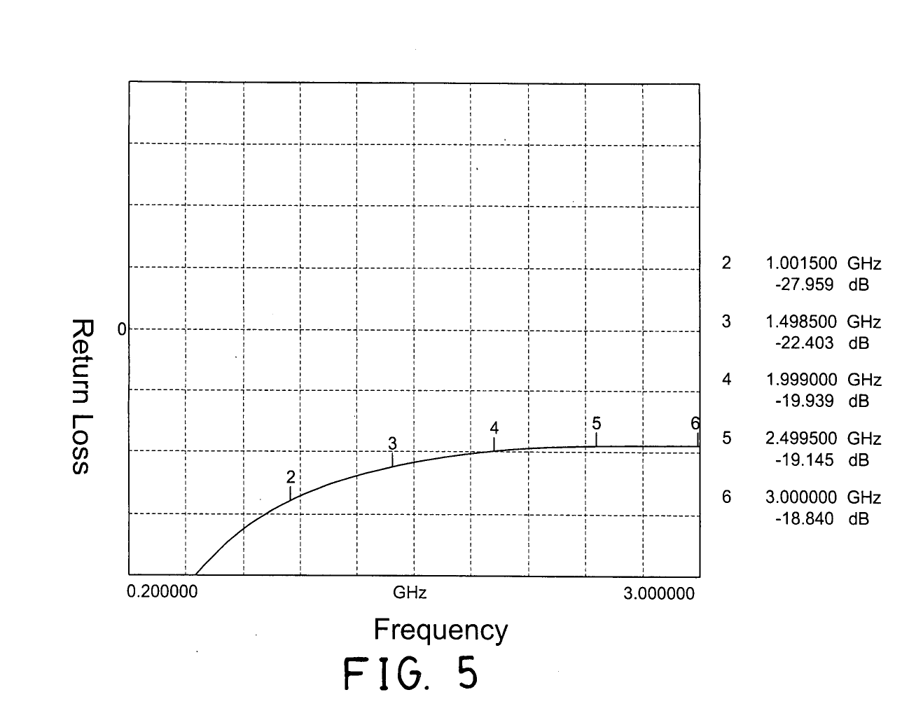

As shown in FIG. 5, when the in-plug electric wire or cable 40 includes an impedance of about 75 ohms, and when the electric connector is operated in the frequency of about 3 GHz, the gain of the return loss is less then −18 dB, such that the return loss of the electric connector may be suitably reduced or decreased.

Accordingly, the electric connector in accordance with the present invention includes a socket member or receptacle having an increased contacting area with the in-plug electric wire or cable for firmly and stably coupling or connecting the in-plug electric wire or cable to the receptacle of the electric connector and for decreasing the impedance between the in-plug electric wire or cable and the receptacle of the electric connector and for reducing the return loss of the electric connector.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric connector comprising:
an adaptor shell including a chamber formed therein,
an insulating device disposed into said chamber of said adaptor shell and including a bore formed therein, and
a receptacle engaged into said bore of said insulating device and including a compartment formed therein for receiving an electric cable, and including at least one slot formed therein for defining at least one blade, said at least one blade including two side segments and an intermediate segment disposed between said side segments and located in said compartment of said receptacle for engaging with said electric cable and for increasing a contacting area between said at least one blade and said electric cable.

2. The electric connector as claimed in claim 1, wherein said insulating device includes a first insulating member disposed in said chamber and at a first end of said adaptor shell and having a bore formed in said first insulating member, and includes a second insulating member disposed in said chamber and at a second end of said adaptor shell and includes a bore formed in said second insulating member.

3. The electric connector as claimed in claim 2, wherein said receptacle is engaged into said bore of said first insulating member, and partially engaged into said bore of said second insulating member.

4. The electric connector as claimed in claim 2, wherein said adaptor shell includes an inner peripheral flange extended radially and inwardly from said first end of said adaptor shell for engaging with said first insulating member.

5. The electric connector as claimed in claim 1, wherein said receptacle includes a conductor member engaged with said receptacle and extended out of said second insulating member and said adaptor shell.
